(19) United States
(12) Patent Application Publication
(10) Pub. No.: US 2007/0094296 A1
(43) Pub. Date: Apr. 26, 2007

(54) Document management system for vehicle sales

(76) Inventor: Richard C. Peters III, Plano, TX (US)

Correspondence Address: HOWISON & ARNOTT, L.L.P, P.O. BOX 741715, DALLAS, TX, 75374-1715, US

(21) Appl. No.: 11/257,540

(22) Filed: Oct. 25, 2005

(51) Int. Cl. G06F 7/00; G06Q 99/00; G06K 9/34; G06F 17/00

(52) U.S. Cl. 707/102; 705/1; 715/500; 382/173

(57) ABSTRACT

A document management system for managing the documents for a purchase transaction. The system includes a database for storing a plurality of electronic customer files. The electronic customer files contain text data and image data. An interface with a dealer management system provides for the input of forms for the generation of the image data and the text data. A control module enables assembly of a portion of the electronic documents in an electronic customer file in the database into a distribution package. The portion of the electronic documents from the electronic customer file are determined based upon a destination third party for the distribution package.

### TECHNICAL FIELD OF THE INVENTION

This invention is related to sales systems, and more particularly, to a system and method for document management within the sales environment.

### BACKGROUND OF THE INVENTION

The sale of an automobile to a customer involves the gathering, creation and execution of a number of documents in order to complete the transaction. Presently these documents are physically gathered, created and stored in a physical file that is associated with the customer. These physical files include both documents that are generated through a dealership's dealer management system and documentation provided by the customer to the dealership in order to complete the sale of an automobile. The physical creation of the files and third party forms associated with a customer's sale can involve a great deal of labor intensive processes. In addition to the time involved in making the file and placing the documents into the file, there is required the time associated with storing and maintaining the file associated with a buyer. Also, the potential exists for various documents to be lost or forgotten when creating a particular customer file. If certain documents are not obtained from a customer during the purchase of an automobile, this will invite unnecessary delay into the purchasing process and funding process when the dealership is required to go back and obtain documents from a customer that they neglected to do so earlier in the automobile purchasing transaction.

In addition to the inordinate amount of time that may go into gathering and maintaining the documents associated with a particular automobile purchasing transaction, a great deal of time and effort is also required in completing a transaction with respect to the generation and provision of documents that are necessary to be provided to third parties and the purchaser in order to complete the transaction. For example, the purchase of an automobile many times requires the obtaining of a loan by the purchaser. In order to obtain a loan, the bank granting the loan requires a number of different documents to be provided to the bank. If the documents and forms required by each bank in order to complete a loan transaction associated with an automobile purchase were the same, this would be a relatively simple process. However, banks require different documents with respect to their loan transaction. Thus, when assembling a document package associated with a loan transaction to be transmitted from the dealership to the bank, care must be taken in providing the correct documents that are required by the particular bank being dealt with. Additionally, various banks may have differing requirements for the way they will accept the loan transaction documents. Some banks may accept electronic copies but have specific requirements as to whether the documents are to be provided in PDF format, TIFF format or raw data in XML format. Additionally, some banks may not accept electronic documents and require physical copies to be sent or faxed to the bank. Alternatively, some banks may require a follow-up hard copy of received electronic documents to be transmitted. These differing requirements by the banks require the auto dealership to not only maintain checklists enabling them to know which documents are to be provided and the manner in which they are to be provided but also require the dealership to go through the exercise of assembling the document specific packages for each institution. Similar types of requirements may be associated with documents provided to the state and county governmental entities in which a vehicle is purchased in order to take care of title transfer requirements.

Thus, there is a need for a document management system that would enable a dealership to more efficiently track the documents and forms associated with the purchase of an automobile and to more quickly and efficiently enable the assembly of packets of information that are provided to third party entities such as banks and governmental entities that are transmitted in association with the purchase of the automobile.

### SUMMARY OF THE INVENTION

The present invention disclosed and claimed herein, in one aspect thereof, comprises a document management system for managing documents within a purchase transaction. The document management system includes a database that stores a plurality of electronic customer files. Each of the electronic customer files contain text data and image data. An interface of the document management system provides a connection with a dealer management system. The interface provides for the input of forms for the generation of the image data and the text data. A control module assembles a portion of the electronic documents in an electronic customer file into a distribution package. The portion of the electronic documents that are assembled is determined based upon a destination third party for the distribution package.

### BRIEF DESCRIPTION OF THE DRAWINGS

For a more complete understanding of the present invention and the advantages thereof, reference is now made to the following description taken in conjunction with the accompanying Drawings in which:

FIG. 1 is a block diagram illustrating the operation of existing document management systems for automobile dealerships;

FIG. 2 is a block diagram illustrating an improved document management system for automobile dealerships;

FIG. 3 is a block diagram of the elements of the document management system;

FIG. 4 illustrates the overall document management system;

FIGS. 5a-5d illustrate the database and file structure associated with an electronic document management system;

FIG. 6 illustrates the manner in which forms may be populated using existing dealer management systems and an electronic customer file associated with the purchase of a vehicle;

FIG. 7 is a flow diagram illustrating the method for populating data into a form;

FIG. 8 is a flow diagram illustrating the operation of the document management system for an automobile dealership;

FIG. 9 is an illustration of a deal cover sheet of the document management system described herein;

FIG. 10 illustrates a multifunctional scanner for scanning documents to be stored within the document management system;

FIG. 11 is a flow diagram more fully illustrating the process for opening a user file within the document management system;

FIG. 12 is a flow diagram more fully illustrating the manner in which additional documents may be entered into an electronic customer file;

FIG. 13 is a flow diagram illustrating the manner in which an electronic customer file may be processed by a finance department of an automobile dealership;

FIG. 14 illustrates a graphical user interface for working documents of an automobile sales transaction;

FIG. 15 is a flow diagram illustrating the manner in which an automobile purchase transaction may be completed using the document management system;

FIG. 16 illustrates the manner in which filing packages may be assembled from an electronic customer file depending upon the destination lender for the filing package;

FIG. 17 illustrates a sales department with a drivers license scanner;

FIG. 18 illustrates the sales department with a printer for printing deal cover sheets;

FIG. 19 illustrates the sales department with a scanner for entering additional buyer documents;

FIG. 20 illustrates how a customer file may be transmitted from the sales department to the finance department;

FIG. 21 illustrates how the customer file may be placed within the finance department queue; and

FIG. 22 illustrates the manner in which the deal may be worked by the finance department in order to complete a transaction.

FIG. 23 illustrates a real time ticker display based on the electronic customer files; and

FIG. 24 is a flow diagram illustrating the method for providing a real time status display based on the electronic customer files.

### DETAILED DESCRIPTION OF THE INVENTION

Referring now to the drawings, wherein like reference numbers are used herein to designate like elements throughout the various views, embodiments of the present invention are illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

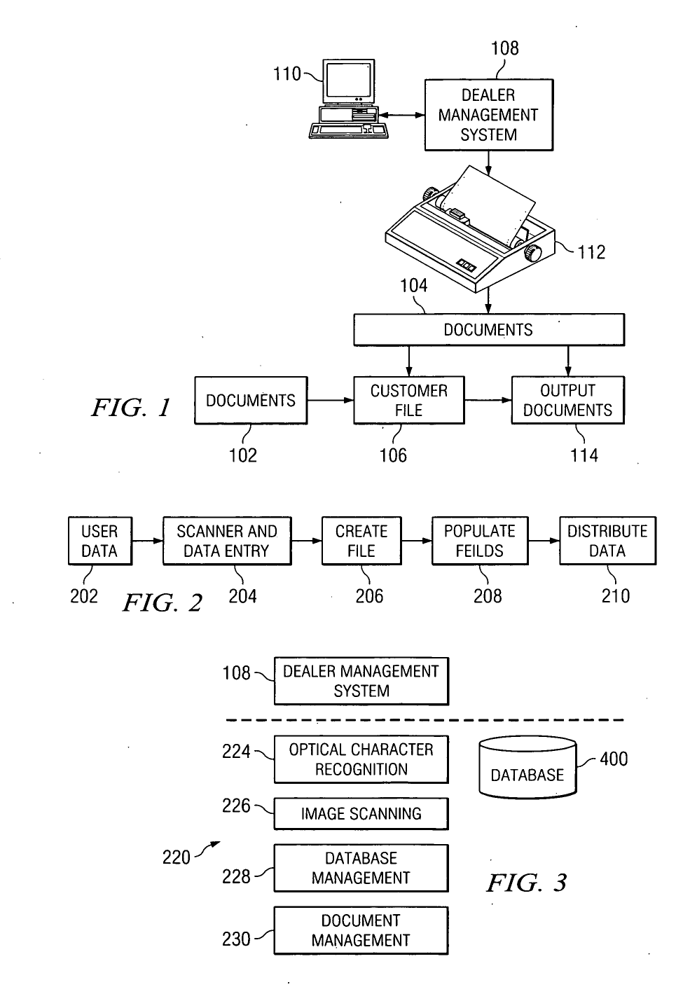

Referring now to FIG. 1, there is illustrated a prior embodiment of the manner in which documents are managed by a dealership in an automobile purchase. While the following description is made with respect to an automobile, the described system is equally applicable to any retail dealership providing the sale of a truck, boat, motorcycle, trailer, mobile home or any other retail dealership. The documents within an automobile purchase transaction are provided from two sources. Documents 102 provided by the customer includes such things as a copy of the drivers license, proof of insurance and utility bills and other similar items. An automobile dealership requires a copy of these items in order to complete an automobile purchase transaction. Copies of these documents 102 provided by the buyer are placed within a physical customer file 106 that is created at the dealership. Additionally, documents 104 and forms created by the dealership are also required to be created and placed within the physical customer file 106. These documents include such things as loan applications, warranty contracts, and credit applications that are necessary in order to complete an automobile purchase transaction. Documents 104 provided by the dealership include hard copies of multi-part forms that must be transmitted via mail or courier service, such as U.S. mail or Federal Express, forms created using the dealership's dealer management system 108, warranty forms related to the vehicle purchase, and dealership forms specific forms. These forms may be proprietary forms used by the dealership or electronic format forms such as DEALERTRACK™. DEALERTRACK™ forms relate on to the credit application process. These documents 104 are also placed within the customer's physical file 106 once they are created.

The dealer management system 108 is a computer based processing system that receives information related to specific forms required by the dealership in order to complete an automobile transaction, such as sales or financing and insurance, from an attached processing unit such as a PC 110. The PC 110 enables a sales representative to enter required data into the forms provided by the dealer management system relating to the automobile purchase transaction. Once all of the required data for a particular form has been entered by the sales representative through the PC 110, the dealer management system 108 causes the data to be printed out in a form on a dot matrix printer 112. The form provided by the dot matrix printer 112 represents all of the information entered by the sales representative on the PC 110 into the dealer management system 108. The form including information entered into the dealer management system 108 is output as a printed form to the dot matrix printer 112. These printed forms from the dot matrix printer 112 are placed within the physical customer file 106. Additional physical forms manually created and handwritten may be copied or printed and placed in the file 106.

Once all of the required documents 102 from the customer and the documents 104 provided by the dealer management system 108 are gathered within the customer file 106, the lender documents 114 are assembled that are required in order to complete the loan applications and title applications. The output documents 114 will vary depending upon the third parties involved with a particular automobile purchase transaction. For example, when different banks are used, different documents will be required to be assembled in different formats depending upon the bank. Thus, someone is required to physically assemble the package from the customer file 106 and to further obtain any additional documents 104 required from the dealer management system 108 in order to complete the output documents 114 necessary to satisfy the particular bank's requirements. Since each bank has different document requirements, a separate checklist must be reviewed for each transaction resulting in the use of a large amount of employee time in order to confirm the proper documents are sent. A similar situation is available for title transfer transactions associated with an automobile purchase transaction depending upon the area in which the transaction is taking place. A typical physical file can contain 50 plus pages. Thus, as can be seen, a variety of time consuming manual processes must be implemented within any particular automobile purchase transaction in order to physically maintain a client's file and confirm that proper documents are being transmitted with respect to any particular transaction.

Referring now to FIG. 2, there is provided an overview of the electronic document system for an automobile purchase transaction according to the present disclosure. User data 202 comprises a multitude of information necessary to complete an automobile purchase transaction. The user data 202 can include information such as an individual's name and address obtained from their drivers license or their insurance provider contained in their insurance card. It can also include information that is provided by the user from filling out a credit application or a loan form associated with the automobile transaction. This user data 202 is input into the document management system of the present system by any number of methods including, but not limited to manual data entry 204, via scanning of a business card or drivers license, an output from the dealer management system of the dealership, or from a fax or email request. Entry of the user data causes the creation of an initial electronic folder for storage of the entered data. For physical documents that are provided by a buyer to a dealership, the scanner would be used for entering this information into the document management system. The scanner may comprise a multifunctional scan to file device including a software package for controlling the scanning. The physical documents provided by the buyer are placed within a scanner and the information obtained by the scanner is recorded such that it may be stored for future use by the document management system. An interface between the scanner and the document management software enables the creation of full text optical character recognition of the scanned documents with a searchable index of the scanned document. User data 202 may additionally be provided to the document management system via physical data entry inputs, such as a sales representative asking a customer questions with respect to a credit application and entering their responses into a pre-created electronic form.

The information provided by the scanner and data entry methods 204 is used to create an electronic customer file 206 into which the information provided by the scanner and data entry method 204 is stored. The electronic customer file 206 is created within a database of the document management system that is capable of interacting with the dealer management system 108 to provide necessary information. The created electronic customer file 206 contains all of the information associated with the automobile purchase transaction. This user data 202 stored within the created electronic customer file 206 is used to populate fields at 208 that are associated with various forms and documents associated with the automobile purchase transaction. The fields are populated with user data 202 extracted from electronic customer files 206.

Once all of the necessary document fields have been populated at 208, the documentation created in association with the automobile purchase transaction is distributed at 210. This distributed documentation includes the forms having fields populated at 208 and any additional documentation that has been scanned into an electronic customer file 206. The distributed documents' are uniquely associated with a destination location. This destination location will have associated therewith certain requirement parameters that must be fulfilled before the information is transmitted to the destination location.

Referring now to FIG. 3, there is illustrated a functional block diagram of the structure of the system for providing document management within an automobile dealership. The dealer management system 108 interacts with the document management system 220 through a database 400. The database 400 is responsible for storing the electronic customer files mentioned herein above. Files are created within the database 400 using optical character recognition software 224 and image scanning software 226. The image scanning software 226 is responsible for creating the images of items that are scanned to be placed within electronic customer files within the database 400. The optical character recognition software 224 extracts data from the images created by the image scanning software. For example, a form created by the dealer management system 108 may be scanned and stored in the database. Data from the stored document may be extracted and used by the electronic document system 220. A database management software 228 controls the storage and movement of information within the database 400. Document management software 230 provides the interface between the database 400 and the dealer management system 108 for receiving forms and documents that must be populated by data contained within the customer files within the database 400 and for controlling the image scanning software 226, optical character recognition software 224 and database management software 228 to place the information within known locations.

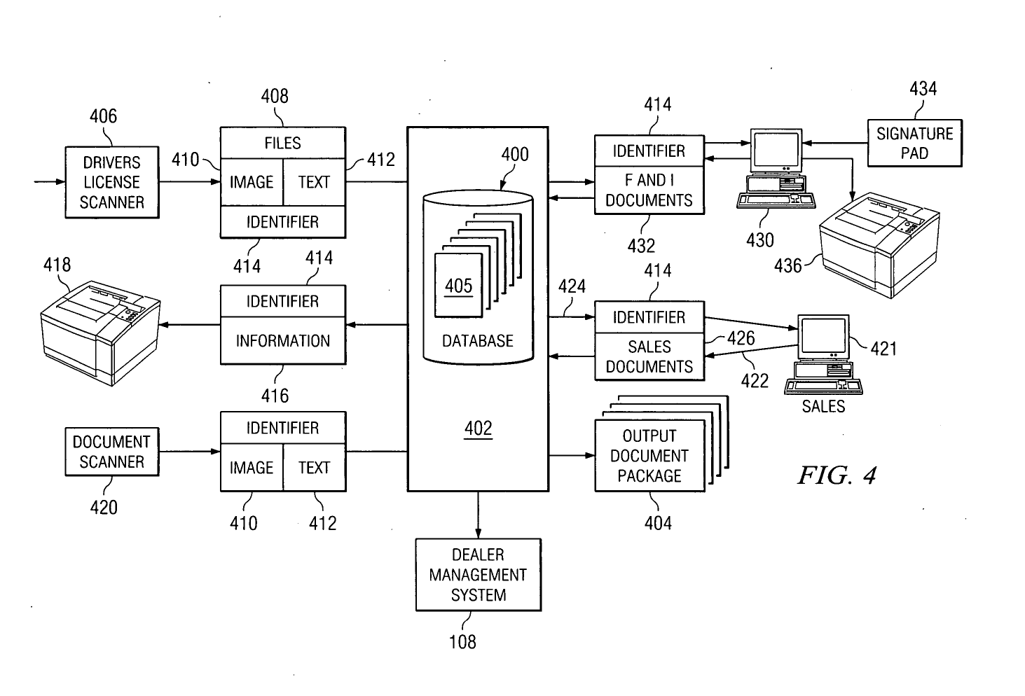

Referring now to FIG. 4, there is illustrated an overall diagram of the document management system for a dealership according to the present disclosure. The document management control is provided via the system database 400 and control software 402 in parallel with the dealership's dealer management system 108. The document management control software 402 is responsible for maintaining each of the electronic customer files 405 that are opened in response to any particular transaction within the database 400. The control software 402 additionally controls the creation of both image and text portions of documents scanned into the system and for populating data fields within forms from text files of scanned documents from the dealer management system 108 and from data entered from connected PCs. The control software 402 also controls the creation of output document packages 404 that are assembled for distribution to lenders, the electronic customer file and other third party entities.

The output document packages 404 are automatically generated based upon previously stored data requirements associated with particular third party entities that are receiving the documents. Thus, in the case of loan transaction documents associated with a particular bank, the documents that the bank requires are automatically pulled from the electronic customer files 206 based upon the information that the bank requires and then e-mailing, faxing or mailing the information to the bank. Documents such as title transfer documents may be sent to specified government entities based upon the county of sale.

Information is input into the database 400 via a number of avenues. One avenue includes the drivers license scanner 406. When a drivers license is placed within the drivers license scanner 406, a temporary buffer file 408 is created, including an image portion created by the scanning of the drivers license scanner 406 and a text portion 412 that is created by optical character recognition of the image portion 410. The image data 410 and text data 412 has an identifier 414 associated therewith and all of this information is forwarded to the database 400 to be stored in an associated electronic customer file 405. The sales associate is provided with a copy of the identifier 414 on a cover sheet 416 that includes the identifier 414 and various information on the potential customer. The identifier 414 may include, for example, a bar code or any other optically recognizable identifier. Additional non-optical identifiers may also be used that provide a unique identifier for the cover sheet 416. This cover sheet 416 will be provided to the sales associate via a printer 418.

Information may be additionally input into the electronic customer files 405 of the database 400 via a document scanner 420. By initially scanning in the cover sheet 416 provided from the printer 418, an identifier 414 may be associated with a scanned document such that any additional image data 410 and text data 412 may be placed in the correct electronic customer file 405 that corresponds to the identifier 414. The image data 410 is created by the document scanner 420 and the text data represents extracted data from the image data using optical character recognition techniques. Data may also be entered into the database 400 via the conversion of dealer management system documents into image and text data in the database 400.

Another avenue of data entry into the database 400 and associated electronic customer files 405 are through PCs 421 within the sales department. Using data entry from PCs 421 in the sales department, sales documents may be created either via data entry 422 from the sales department PC 421 or via extraction of text data 424 from information contained within the electronic customer files 405. These sales documents 426 created between the sales department PCs 421 and information contained within the database 400 will also have the identifier 414 associated therewith such that when the sales documents 426 are completed, the document management system will know which customer file 405 to associate the sales documents with. Users of the document management system may also utilize a connected PC 421 to request that the document management system software 402 run various reports and queries concerning information contained within the database 400. This may include, for example, a sales manager requesting an update on the status of a sale presently being managed by one of his sales associates. This could provide the sales manager the present terms of the agreement and the amount of time that has passed since the electronic customer file 405 was initially opened. An LCD panel display could also provide such managers live activity reports on all aspects of a sale such as time on lot and status of process.

Information may also be entered into the electronic customer files 405 through the finance department PCs 430 and associated peripheral devices. The finance department PCs 430 may be used to create finance documents 432. These finance documents 432 will also have associated therewith the unique identifier 414 identifying which particular electronic customer file 405 the information is to be stored within. Information within the finance documents 432 are created from a combination of data extracted from the electronic customer files 405, data entered from the finance department PC 430 and signature information provided by a customer through an associated signature pad 434. By signing the form signature pad 434, a customer may electronically place their signature or initials upon documents being displayed upon the finance PC 430. Signature pad control software allows any document to be divided into 8.5×11 pages that may be individually signed off on by a customer as the pages are reviewed. The signed finance documents 430 are stored upon the associated electronic customer file 405 within the database 400. Additionally, the finance PC 430 may be used to provide the signed documents to the customer through an associated printer 436. F&I applications, warranty, life, etc. documents, the majority of which are now printed on a dot matrix printer may now be generated electronically.

The dealer management system 108 also provides information to the F&I PC during the process of creating documents. Output from the dealer management system 108 may be captured by the document management system 402 and stored within a particular customer file 405 with which the transaction is associated.

The output document packages 404 are automatically generated by the document management control software 402 based upon previously stored data requirements associated with particular third party entities that are receiving the document packages 404. Thus, in the case of loan transaction documents associated with a particular bank, the documents that the bank requires are automatically pulled from the electronic customer files 405 based upon the information that is known the bank requires and then e-mailing, faxing or mailing the information to the bank. Documents such as title transfer documents may be sent to specified government entities based upon the county of sale. The format of the distribution has also been previously established as PDF, TIFF or other type of electronic or physical distribution for the image data and XML, CSV or other format for the non-image data. The documents may be transferred by e-mail, SSL secure transfer, mail, fax, electronic Internet fax, etc.

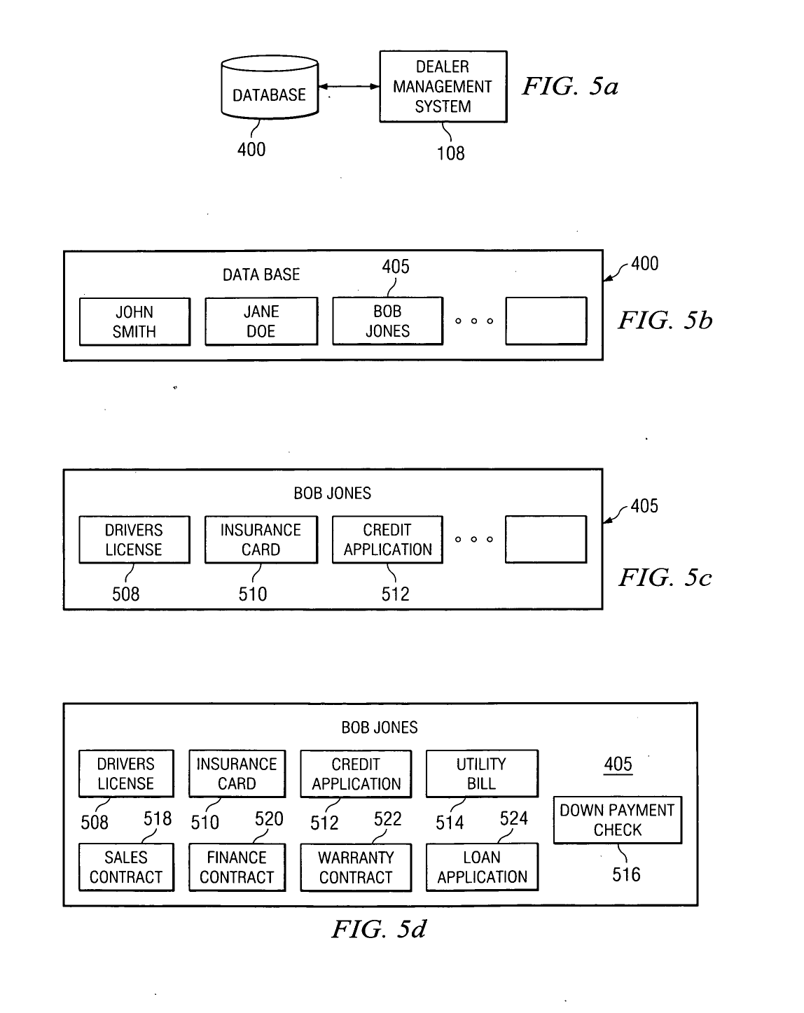

Referring now to FIGS. 5a-5d, there is illustrated the database 400 and file structure to provide necessary data and documents to complete an automobile purchase transaction. The dealer management system 108 and database 400 may be interconnected via any third party service/software/hardware solution. FIG. 5a illustrates a top level block diagram illustrating a database 400. The database 400 contains each of the electronic customer files 405 (FIG. 5b) that electronically store forms and documents that are associated with a particular automobile purchase transaction. Data is downloaded from the dealer management system 108 to the electronic customer files 405 in order to store the data associated with the automobile purchase transaction(s) in the database 400. The electronic customer files 405 are each uniquely associated with the customer and a sales associate(s). The files 405 also include electronic copies of all generated forms and customer provided physical documents.

Referring now to FIG. 5c, there is more fully illustrated the contents of the electronic customer file 405. The electronic customer file 405 will initially include documents that have been scanned into the customer's file. These scanned documents may be used at a later point as the transaction proceeds to enable the creation of forms and documents necessary to complete the automobile purchase transaction. The electronic customer file 405 will include scanned documents such as a purchaser's drivers license 508, their insurance card 510, or a credit application 512, that has been filled out by the customer. Additional scanned documents may be included within the electronic customer data file as required by the particular dealership at which the purchase is made.

Referring now to FIG. 5d, there is illustrated the contents of the electronic customer file 405 wherein the transaction has been completed and includes all of the documents necessary to indicate a finished automobile purchase transaction. These electronic documents within the electronic customer file 405 include scanned documents such as the drivers license 508, insurance card 510, and credit application 512 discussed above with respect to FIG. 5c and additional scanned documents, such as a utility bill 514 and a copy of the down payment check 516, indicating that the down payment on the purchase has been made. Additional documentation that may be created by the system using information extracted from the above-described scanned documents include a sales contract 518 for the automobile, finance contract 520 establishing the terms of a loan for the automobile, a warranty contract 522 which the user may purchase for the vehicle and a loan application 524 which a purchaser may use to apply for the loan defined by the finance contract 520. All of this electronic information within the electronic customer file 405 may be used to configure packages for sending to various lenders and governmental entities that are a part of any automobile purchase transaction such as a bank providing a loan or governmental entities required to be notified of change of title.

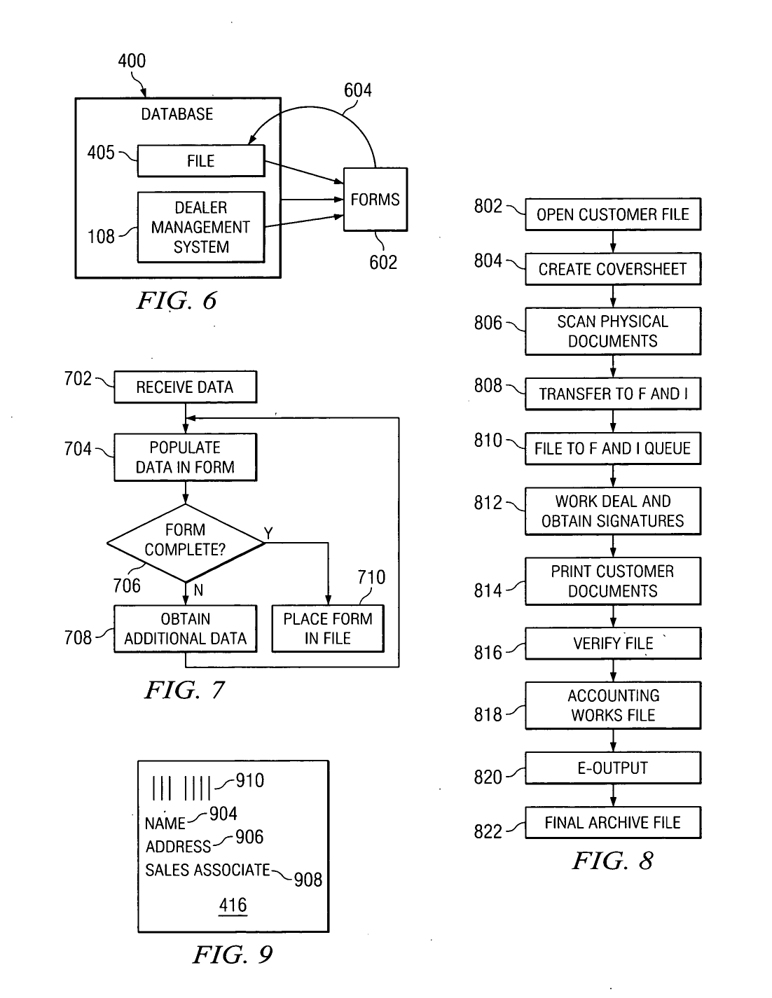

Referring now to FIG. 6, there is more fully illustrated the manner in which forms 602, such as the sales contract, finance contract or warranty contract may be created using the electronic customer file 405 in accordance with the control software 402. The electronic customer files 405 include the scanned documents containing information such as name, address, social security number and the like that are necessary to fill out the forms 602 necessary to complete an automobile purchase transaction. This information is extracted from the scanned documents within the electronic customer file 405 and used to populate data fields of the forms. The data from the forms of the dealer management system 108 or other scanned documents are output to forms 602 and the forms are saved in the database 400. The blank forms to be populated reside in the database 400. Alternatively, forms created by the dealer management system may be used after they are stored electronically in a customer file 405. An application associated with the document management software 402 is used to push data from the electronic customer file 405 into the data fields within the blank forms. Once the blank form has been completed, it may be stored in the electronic customer file 405 at 604. This process is more fully illustrated in the flow diagram of FIG. 7.

Referring now to FIG. 7, data is received from the electronic customer file 405 at step 702. The data received from the electronic customer file 405 is used at step 704 to populate data fields of the necessary blank forms for the automobile purchase transaction. When the data fields of the blank forms have been populated, inquiry step 706 determines whether the form has been completed. If it is determined that the form has not been completed, additional information may be obtained at step 708 from the electronic customer file 405. This may involve merely downloading additionally extracted customer data to complete the form or requiring additional physical input via scanning or computer entry to obtain the necessary data. Once the additional data is obtained at step 708, it is used to populate the form at step 704. Once inquiry step 706 determines that the form has been completed, the completed form is stored in the electronic customer file at step 710.

Referring now to FIG. 8, there is more fully illustrated the overall operation of the document management system for use with an automobile purchase transaction. The process begins at step 802 by opening an electronic customer file 405. This process is accomplished automatically responsive to scanning in an initial buyer document, such as a drivers license, which will be more fully discussed herein below. A sales representative which is presently providing services to the new customer is assigned access to the created electronic customer file 405. Once the electronic customer file 405 has been opened, a customer cover sheet is created at step 804. The customer cover sheet 416, illustrated in FIG. 9, contains various pertinent information about the customer involved in the automobile transaction and includes information such as the name 904, address 906 and the sales associate 908 associated with the transaction. The cover sheet 416 also provides a bar code identifier 910 that is uniquely associated with the electronic customer file 405 that has been created within the database 400. The bar code identifier 910 is used when scanning in physical documents at step 806. The bar code identifier 910 also protects the privacy of sensitive data. Prior to scanning in a physical document, the cover sheet 416 is be used to identify the electronic customer file 405 with which the scanned physical document is to be associated by scanning the identifier 910. While the present disclosure describes uses a bar code upon the cover sheet associated with the electronic customer file as an identifier, any other method for providing a unique identification 414 to the electronic customer file 406 may be used. These might include the use of a smart card issued to the customer upon their entry into the dealership, a unique code associated with the customer, or even using items previously provided to the dealership, such as the customer's drivers license. The identifier must only provide the ability to uniquely identify an associated electronic customer file 405.

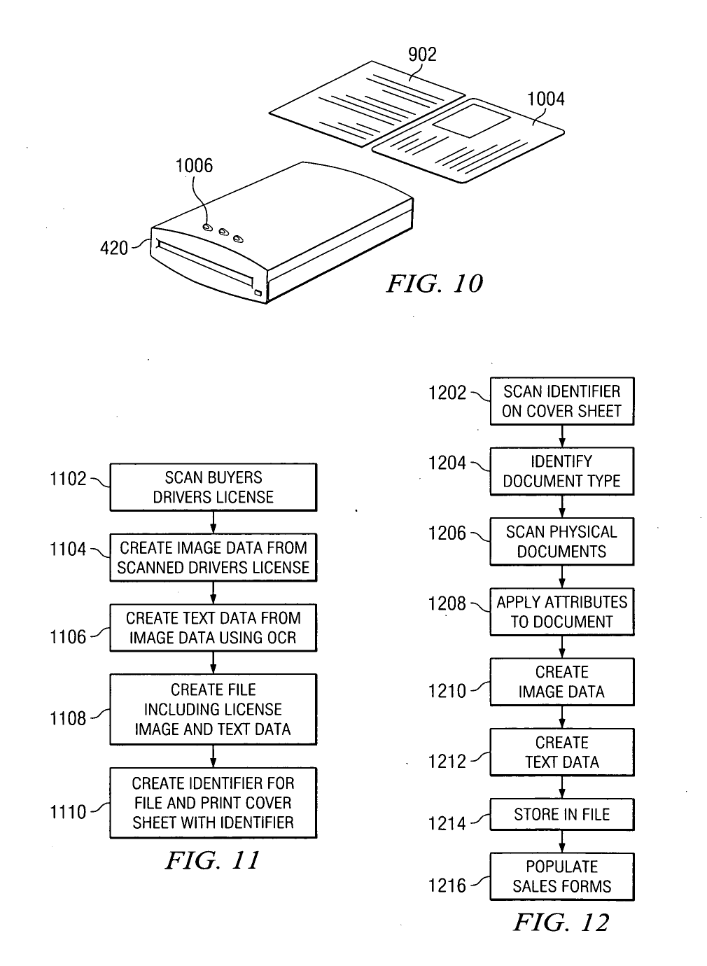

Referring now also to FIG. 10, there is provided one example of a scanning station 420 which may be used to enter physical documents into the electronic customer file according to the present disclosure. In this case, a document 1004, such as a proof of insurance, is desired to be input into the document management system. Before the document 1004 may be scanned into the system using the scanning station 420, the sales representative must first scan the transaction cover sheet 902. Transaction cover sheet 902, as mentioned herein above, will identify the particular electronic customer file 405 into which electronic copy and data of the scanned document 904 must be placed. When the document 1004 is scanned into the scanning station 420, the user presses one of a number of buttons 1006 on the scanning station 1002. Each of these buttons 1006 identifies a particular document type that is being scanned into the system. Thus, for example, one of the buttons 1006 associated with the scanning station 420 would be a button for a proof of insurance document. When the insurance document 1004 is scanned into the system, this button would be pressed, and the system would know which document attributes to associate with the document 1004 being scanned into the system. The document attributes allow the document management system to know what data should be extracted from the document 1004. If no button is pressed when a document is scanned, the scanned document file is identified as a general document by the document management system. When a document file is identified as a general document, the document manage system will later provide a prompt to ask for an identification of the document in the document file so that document attributes for the file may be established.

Referring now back to FIG. 8, once any necessary physical documents have been scanned in at step 806, access privileges to the electronic file may be transferred from the sales department to the F&I department at step 808 to complete the financial aspects of the transaction. When the electronic customer file 405 is received at the finance department, it is put within the finance department queue at step 810 to await action by one of the employees of the finance department. Once the electronic customer file is accessed by one of the finance employees, the employee would work with the customer to sell any desired contracts and packages that the customer may wish to include with their automobile purchase. This process involves filling out all the documents and obtaining all of the necessary signatures required by the customer. Data is entered into a document by extracting it from the electronic customer file 405, provision from the scanned dealer management system documents or manual entry by the F&I department employee. The signatures are provided via an electronic signature pad. The customer signs the electronic signature pad, and the signature is electronically transferred to the documents which are being processed. Some disclosures within documents to be signed by a customer are required to be contemporaneously provided proximate to the customers signatures. The control software of the signature pad and the document management system provide the ability to display the disclosure that must be displayed next to a signature according to law and transfers the disclosure and the signature onto the electronic document. Once all of the necessary customer signatures are obtained at step 812, a customer package copy of the purchase documents may be printed for the customer at step 814. The closing package to the customer may include a thank you letter, service discount, dealership information, referral cards or other marketing related material to assist in the future business relationship with the dealership.

The file may be transferred from the finance employee to the F&I department manager, such that the manager may verify the file at step 816. The verification process involves the F&I department manager reviewing all of the information contained in the file and determining whether additional information from the customer is necessary. The F&I manager may be assisted in this process by an electronic checklist that notifies them of particular documents or items that may be missing from the electronic customer file 405. The electronic customer file 405 may not be forwarded onto the accounting department for final processing until each of these checklist items have been met. Once the electronic customer file 405 has been forwarded to the accounting department, accounting works the file at step 818 to verify that all necessary checks and documentation have been received.

An electronic distribution of all required documentation is provided at step 820. The method of electronic distribution may vary depending upon the third party entities involved in completing the transaction. For example, different banks associated with the transaction may require different documents in a different file format such as PDF, TIFF (image data) or even a printed physical or fax copy and XML, CVS or other format for non-image data. The electronic document system is internally configured to already know the particular requirements of the bank and automatically forward the documents in the correct fashion. Alternatively, requirements for local and state governmental entities can be automatically processed and forwarded in the electronic or physical format required by the governing laws. The final documents are then submitted to an optical character recognition process and indexed so that a final, searchable archive file may be created for storage at step 822.

Referring now to FIG. 11, there is more fully described the steps of opening a customer file and creating a customer sheet as discussed with respect to steps 802 and 804 of FIG. 8. The process is initiated by scanning in the buyer's drivers license at step 1102. Scanning of the drivers licenses creates image data of the scanned drivers license at step 1104. This image data is used to create text data at step 1106 by extracting the text data from the image data using optical character recognition. Alternative methods of character recognition may also be used. In this manner, information such as the customer's name and address may be obtained from the scanned image of the drivers license. In additional embodiments, the information contained within the scanned drivers license may further be verified by the document management system. This process of verification could be achieved by accessing databases which would be publicly available to the document management system via, for example, the Internet, and comparing the information provided via the drivers license scanned to information contained within these external databases. Once the image and text data from the drivers license are obtained, the electronic customer file 405 is created such that the provided image (PDF, TIFF, etc.) and text data (XML, CVS or other format) of the buyer's drivers license may be stored therein at step 1108. After creation of the electronic customer file at step 1108, a unique identifier 414 is created for the file at step 1110. This unique identifier 414 is provided to the sales representative on the printed cover sheet 416 to enable the scanning of additional documents into the system as necessary.

Referring now to FIG. 12, there is more fully illustrated the manner in which physical documents may be scanned into the document management system as described at step 806 of FIG. 8. Initially, the identifier 414 on the cover sheet 416 associated with the electronic customer file 405 is scanned at step 1202 such that the electronic customer file 405 into which the scanned documents are to be placed may be uniquely identified. Next, at step 1204, one of the buttons 1006 on the scan station 1002 is pressed in order to identify the type of document which is about to be scanned into the system. These may identify the document to be scanned as a drivers insurance card, utility bill, or any other type of document that is necessary to complete an automobile purchase transaction. The document associated with the identified document type is scanned at step 1206 into the scan station 802. The scanned document image has applied to it at step 1208 the document attributes associated with the identified document type. This will assist in the extraction of data from the image created by the scan process. The image data from the scanned document is created at step i 210. This image data comprises a picture in PDF, TIFF or other type of visual format that enables a visual view of the scanned document to be recreated. Using the attributes applied to the document by the selected scan button, text data in XML, CVS or other format is extracted from the image data to create the text data associated with the scanned document image using, for example, OCR techniques. However, other types of character recognition techniques may be used. The attributes enable the system to know where the text data contained in the form is likely to reside. This text data may be used in populating forms or documents that must be completed. Next, at step 1214, both the image data and the extracted text data are stored within the electronic customer file. Further with respect to step 1214, in addition to extracting the necessary data and storing it within the customer's electronic file, the dealer management system extracts data from the electronic customer file and uses this extracted data to populate information within a dealership's dealer management system. This may be used to populate various electronic fields required within the dealer management system in addition to the population of the sales forms discussed below with respect to step 1216. This stored data may be used to populate additional sales forms at step 1216 using other applications.

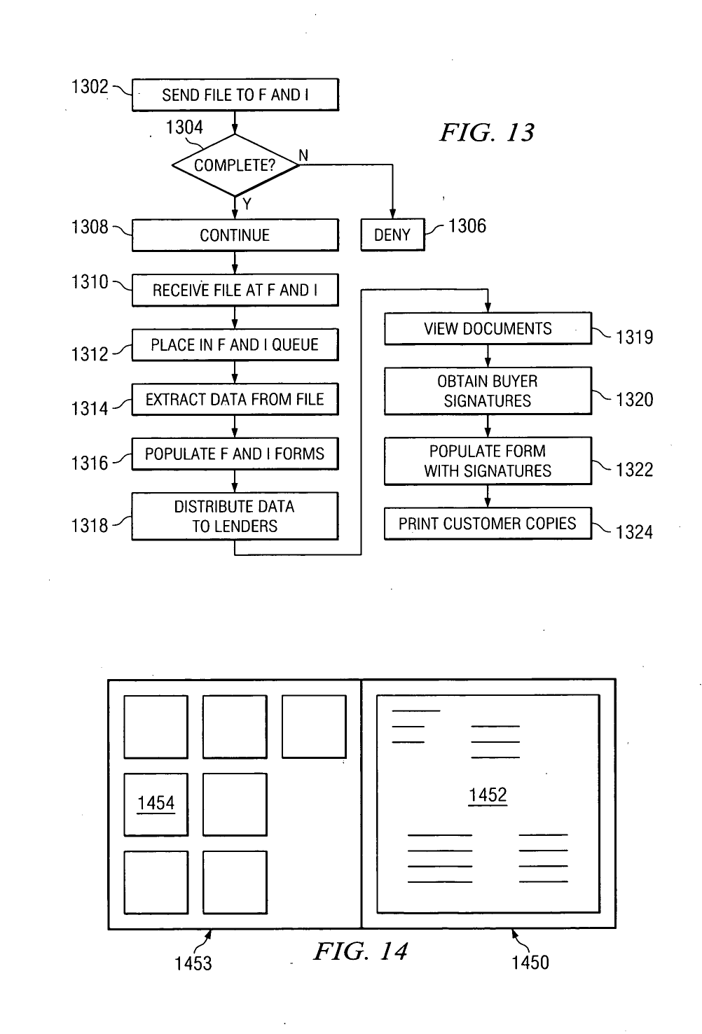

Referring now to FIG. 13, there is more fully illustrated the process occurring within the finance department associated with steps 808 and 810 of FIG. 8. The electronic customer file 405 is initially queued for transfer to the F&I department at step 1302. Inquiry step 1304 determines whether or not the information being transferred to the F&I department is complete. If the information is not complete, transfer to the finance department is denied at step 1306, and the additional required information must be obtained in order complete the transaction. If the required information has been completed, the process continues at step 1308, and the electronic customer file is received at the F&I department at step 1310. The F&I department manager will place at step 1312 the electronic customer file in the F&I department queue such that it will be taken up by a F&I department employee in its received order. Once a F&I department employee has accessed the electronic customer file 405, necessary data for completing the F&I forms and applying for credit applications is extracted from the electronic customer file at step 1314. The necessary loan forms are populated in the dealer management system 108 at step 1316. The created forms are captured and reformulated into laser forms for archiving.

Once these forms have been populated, the forms are distributed to lenders at step 1318 in accordance with the requirements of the individual lenders to obtain loan approval. Each lender will require a particular type of information in a particular format. Some lenders may require the documents to be printed off and the documents to be physically sent to the lender. Other lenders may have the documents sent to them through an SSL transfer in image and/or text data format. Finally, some lenders may enable the document management system to populate an HTML web application via the Internet. The system described herein knows the information, format and method of delivery required by each particular lender and automatically provides this information to the lender without a document package being physically assembled and mailed and/or faxed to the lender. The necessary forms and documents are automatically extracted from the electronic customer file and assembled in the appropriate package. Thus, a great deal of time savings may be realized since the package is automatically created whether in electronic or physical format that is necessary in order to receive a loan decision from a lender.

Next, a F&I department employee goes over various F&I department documents, such as loan applications or warranty contracts, at step 1319 by accessing a real time view of the documents from the electronic customer file 405. The F&I department employee would have a graphical user interface (GUI) in their computer screen displaying a real time image 1452 of the particular document being worked on, as illustrated in FIG. 14, in a first portion 1450 of the graphical user interface. The GUI would further provide thumbnail views 1454 of other documents within the electronic customer file 405 in a second portion 1453 of the graphical user interface enabling the employee to view these documents as necessary.

Signatures for various documents required to be signed by the customer purchasing an automobile are obtained via signature pads within the F&I department. Signatures on various documents are obtained at step 1320 by having the customer sign the signature pad. This creates an electronic copy of their signature which may be electronically placed upon a document at step 1322. Once each of the necessary documents have been signed and/or initialed by the customer using the signature pad, customer copies of all the relevant documents may be printed out for the customer's records at step 1324. The documents for the dealership are of course maintained within the electronic customer file 405 associated with this transaction.

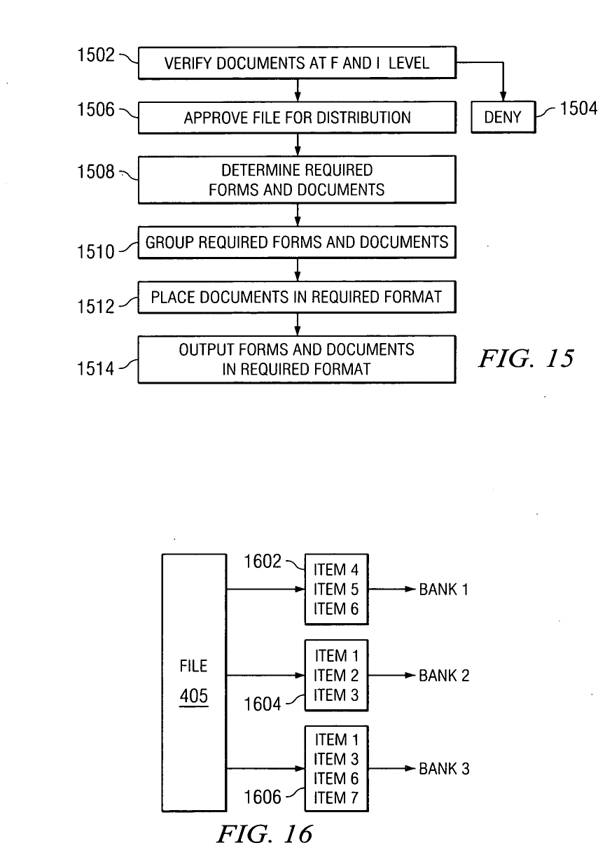

Referring now to FIG. 15, there is more fully illustrated the process by which the electronic customer file documents are verified and electronically distributed to the appropriate third parties as previously discussed in steps 818 and 820 of FIG. 8. The information and documents within the electronic customer file 405 must be verified by both the F&I department at inquiry step 1502. This involves going through an electronic checklist associated with each file and determining that all of the information required by the document management system is present within the file. Items not present may be automatically brought to the reviewer's attention. Additionally, the system may have conditional formatting of data entry fields such that if one of a predetermined number of options are not selected, and a non valid option is entered, a notification will be provided of an invalid data entry. If all of the necessary information is not present within the electronic customer file 405, the forwarding for further processing is denied at step 1504. Once the documents have been verified and approved by both the F&I department at inquiry step 1502, the electronic customer file 405 is approved for electronic distribution at step 1506. Once the file has been approved for distribution, a determination must be made of the required forms and documents that must be distributed for the particular electronic customer file at step 1508. This will involve determining the particular lenders and third party entities that must be notified in order to complete the automobile transaction. This information is stored in preset database which is accessed by the document management system to make the appropriate determinations.

In the case of lenders, various loan documents and contracts associated with the automobile transaction must be provided to the lender in order to satisfy their loan requirements. These documents will vary from lender to lender, but the document management system will automatically know which particular documents are required by each particular lender. Furthermore, the lenders may require the documents in various formats. For vendors accepting electronic copies of documents, the documents may be required in either an image format (PDF, TIFF, JPEG, etc.) or text data format (XML, CSV, comma delimited, etc.) This enables lenders to easily interface with the system since documents are provided in vendor compatible format. Some lenders, however, still require physical copies of documents and, in these situations, the documents necessary would be automatically printed out to be faxed and/or mailed to the associated lender. Additional third party entities which would have to be notified with particular document requirements include state and local government entities required to be notified of transfer of title requirements. Other third party entities might involve the insurance company of the purchasers such that may automatically received any required documents as a service to the customer and/or as required by the lending institution in order to obtain control of the car by the customer.

The required documents for the various third party entities are grouped at step 1510 into a package or packages for transmission. These documents are placed at step 1512 in the required format, be it PDF, TIFF or other format or physical copies. The required documents are output in the desired format at step 1514 to the third party entities. In the case of electronic documents, these can be automatically sent to the third party entities via email, SSL-secure transmission, HTTP, FAX, or output for email. In the case of physical documents, these may be transmitted to a fax server if the third party accepts fax documents, or output to a printer if the third party requires original copies of the documents.

The process of assembly packages for various banking entities described with respect to FIG. 15 is more fully illustrated in FIG. 16. Electronic customer file 405 can be used to pull various items (documents) needed for a distribution package depending upon which of the banks are involved in a particular lending transaction. Thus, for example, if loan documents are being transmitted to bank 1, distribution package 1602 is assembled including item 4, item 5 and item 6. However, if bank 2 were used for the loan transactions, differing documents would be required in the distribution package 1604 and item 1, item 2, and item 3 would be included within the package 1604. Finally, if bank 3 is used, the distribution package 1606 could include a combination of items from the first two packages and some additional ones not required by the other banks, such that four items, item 1, item 3, item 6 and item 7 would be included. The advantage of this system is that the filing documents required by any other banks are automatically known and assembled by the document manage system control software, and the filing package 1602, 1604, 1606 may be automatically generated from the documents within the electronic customer file 405 without requiring an individual to physically assemble these documents from a physical file. This avoids unnecessary transaction delays when the banks are not been provided with the correct documents when human error caused an individual to inadvertently fail to include a particular item required in a distribution package.

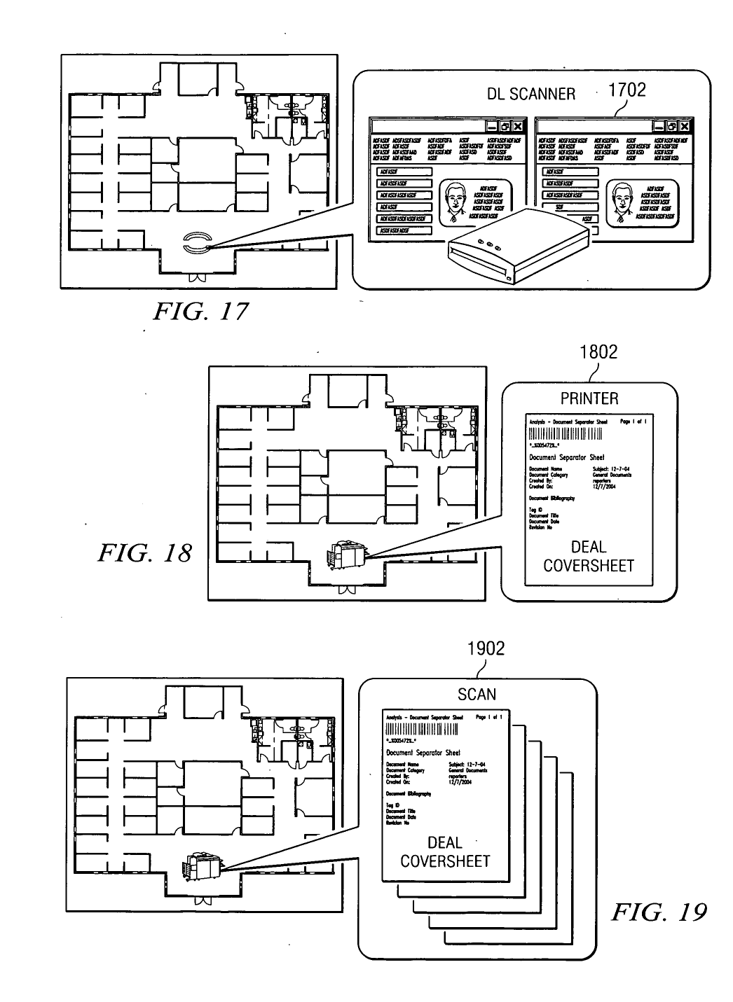

Referring now to FIGS. 17-22, there is illustrated the various manners of document flow through an automobile dealership using the automatic document management system of the present disclosure. FIG. 17 illustrates the initiation of the process within the automobile dealership. When a customer, John Doe, first enters, the electronic customer file for John Doe is opened by the scanning of John Doe's drivers license at an associated drivers license scanner 1702. This could be done at a kiosk, by the sales secretary, by the sales representative, or by the sales manager. This could occur in the foyer of the automobile dealership at an entry or reception area when John Doe first arrives. Next, concurrently with the scanning of the drivers license, a deal cover sheet may be printed as illustrated in FIG. 18. This will be provided from a printer 1802 within the same dealership foyer area and would immediately provide a sales associate with a bar code identifier and relevant transaction information that may be quickly referenced and used to access the associated electronic customer file. In the same sales department area, as shown in FIG. 19, additional documents may be scanned into the electronic customer file using the document scanner 1902 and the previously provided dealer cover sheet. These documents could be scanned into the system as the sales process was progressing. These document scanners could be again associated in the dealership foyer or located within the individual sales associate cubicles or offices.

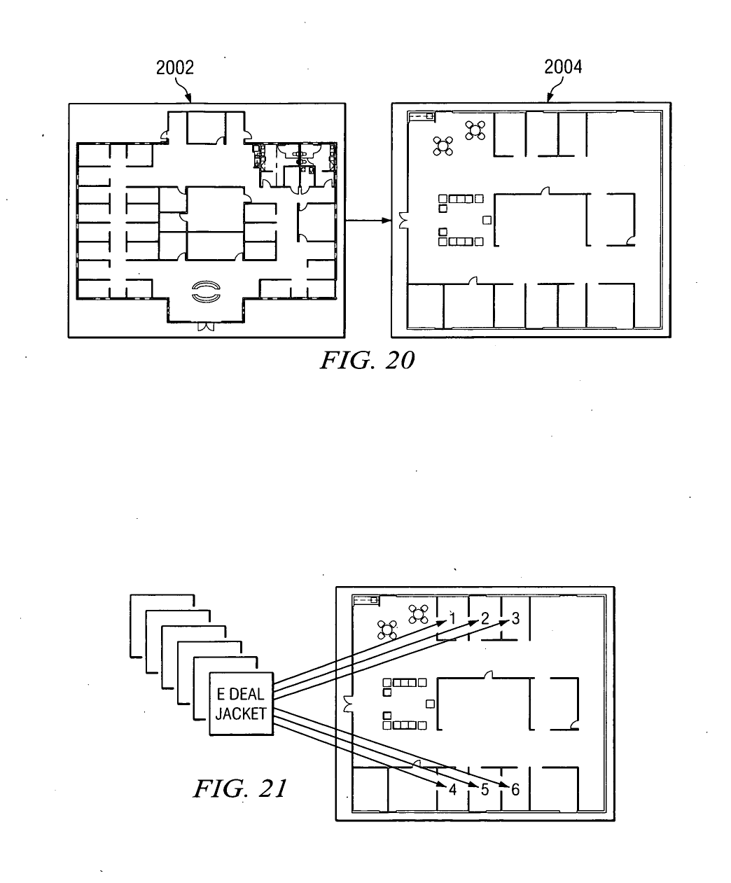

Once all of the sales information was completed, access to the electronic customer file could be transferred from the sales department 2002 to the sales manager to the finance department 2004 as shown in FIG. 20. Once the control of the file was transferred to the finance department 2004, the sales department 2002 would no longer have the ability to enter data within the electronic customer file. All data entry would then be under control of the F&I department 2004. Before transfer of control of the file from the sales department 2002 to the F&I department 2004, a final verification could be performed by the sales manager within the sales department 2002. This would involve going through a checklist to make sure all documents and information required by the F&I department 2004 had been entered into the electronic customer file.

As shown in FIG. 21, once the electronic customer file 405 had been transferred to the manager of the F&I department, the electronic customer file 405 is placed within the operations queue of the F&I department. This would allow the electronic customer file to be assigned to the next available F&I department associate that was available after previously received files had been serviced. Additionally, since the file was electronically transferred to the F&I department from the sales department while John Doe is being taken from the sales department to the F&I department, initial operations may be carried out using the provided electronic customer file prior to the actual arrival of John Doe within the F&I department.

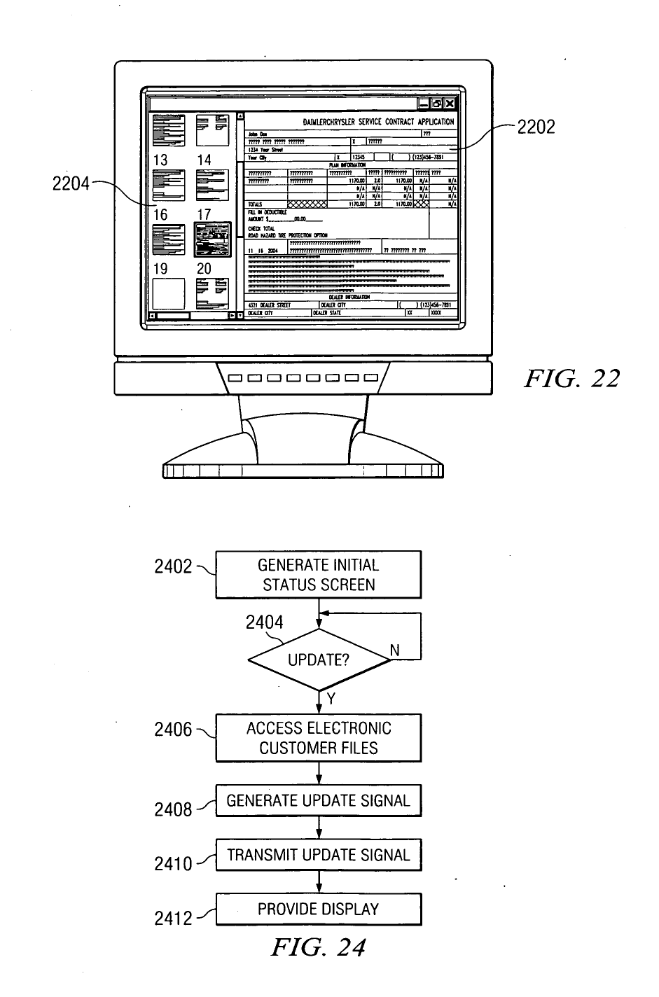

Finally, the F&I department may create the appropriate documents necessary to enable completion of the automobile transaction. During this process, documents can be displayed upon the computer screen of a particular F&I department associate as shown in FIG. 22 such that the document being worked on is on an active screen 2202 of the F&I department associate. Additionally, a summary portion 2204 of the screen may provide thumbnail views of each of the documents contained within a John Doe's electronic customer file such that these documents may be pulled up and worked on, usually by the F&I department associate as needed. As described herein above, signatures to the documents upon the active portion 2202 of the screen may be obtained by John Doe signing an associated signature pad connected with the system.

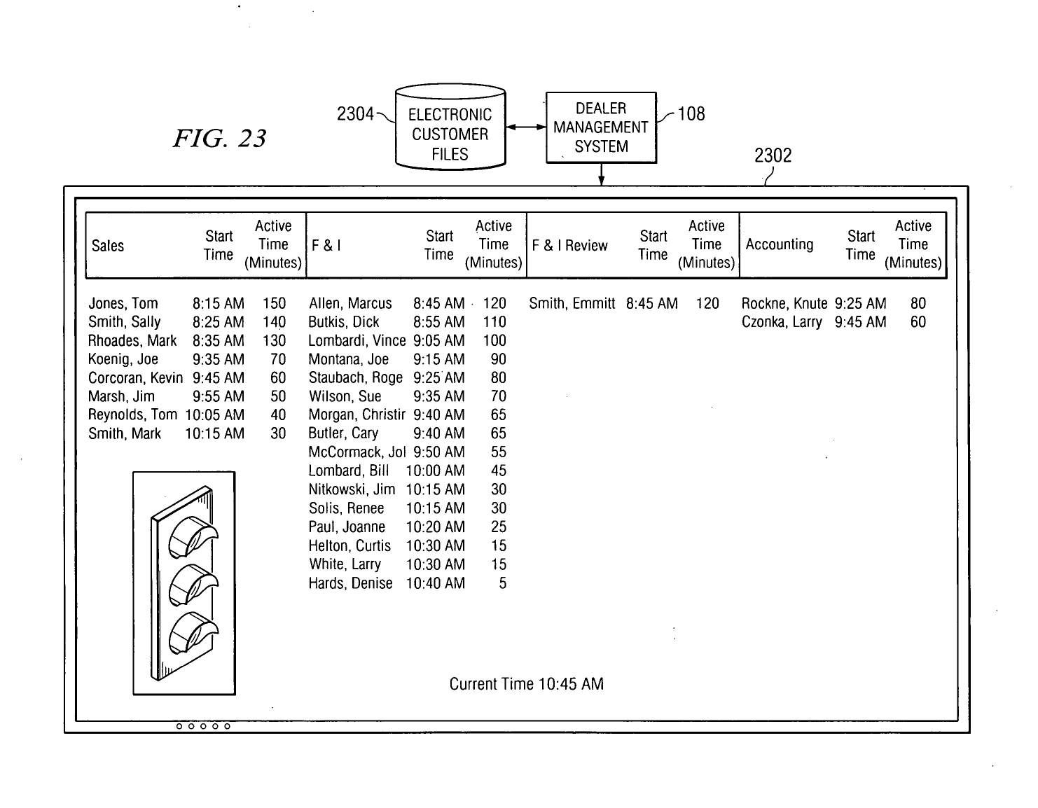

Referring now to FIG. 23, there is illustrated another functionality provided by the dealer management system 108 wherein a running ticker of all activity in the dealership may be provided to various parties on a real time display 2302. Within an automobile dealership there are at least three people that would have an interest in a continuous update of customer activity within the dealership. These would include the sales manager, the finance and insurance (F & I) manager and the general manager. Each of these three individuals may have displayed on, for example, an LCD display within their office a running update of activity within their particular areas of interest. The display 2302 for the sales manager would indicate the number of customers on their lot and provide a color, picture, numeric or other type of identifier indicating the stage in the purchase process at which the customer presently resides. This would provide the sales manager with an indication of whether he needed to become involved in a particular deal or hurry a salesman along to better manage customer flow.

With respect to a display viewed by the F & I manager, this would provide this individual with a more detailed snapshot of their current work flow and the work load to be expected within the future. Thus, for example, if it was apparent that a number of deals were about to be completed and forwarded to the F & I Department for processing, the F & I manager would have a better understanding of the number of individuals that he would require to support upcoming activity. Likewise, the general manager would be provided an overall view of the operation of the dealership to have information necessary to determine when certain individuals might need to be spoken with with respect to problems within the customer flow through the dealership.

The information displayed by the graphical user interface running in each of these managers' offices are generated by the dealer management system 108 from data contained within the electronic customer file 405. By analyzing the data within the electronic customer file 405, the software may generate the particular classifications for a customer and display the customer with its associated classification on the running ticker board as illustrated in the flow chart of FIG. 24.

FIG. 24 illustrates the manner in which the document management system may generate the real time ticker for display in the offices of the above described managers. The system initializes a status screen at step 2402 providing either a base screen with no statistics displayed or a screen indicating that present statistics are being updated. Inquiry step 2404 determines whether an update is presently necessary. If not, control passes back to step 2404 until the time for an update is reached. Once inquiry step 2404 determines that an update is necessary, the document management system accesses the electronic customer files at step 2406. From the accessed electronic customer files an update signal indicating the status of each of the customers within a dealership is generated at step 2408. Once this update signal is generated, the signal is transmitted at step 2410 to each of the above described managers or to any individual to which a real time ticker screen has been provided. Once the update signal is transmitted, the display is provided at step 2412 such that the appropriate individual can take any necessary action based upon the viewed screen.

It will be appreciated by those skilled in the art having the benefit of this disclosure that this invention provides a document management system for automated purchase transactions. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. A document manage system for a purchase transaction, comprising:
a database for storing a plurality of electronic customer files, the electronic customer files containing text data and image data;
a first interface with a dealer management system, the interface providing for input of forms to the database for the generation of the text data and the image data for electronic customer files; and
a control module for assembling a portion of electronic documents in an electronic customer file in the database into a distribution package, wherein the portion of the electronic documents that are assembled is determined based upon a destination third party for the distribution package.

2. The document manage system of claim 1, further including:
a second interface for receiving scanned image data of a physical document; and
a character recognition module for extracting the text data from the scanned image data and forms from the dealer management system.

3. The document manage system of claim 2, wherein the character recognition module associates particular attributes with a scanned documents to extract the text data responsive to a user provided indication.

4. The document manage system of claim 2, further including a scanning module for creating the scanned image data from a scanned physical document.

5. The document manage system of claim 1, wherein each of the electronic customer files contains at least one electronic document associated with the vehicle purchase transaction.

6. The document manage system of claim 3, wherein the at least one electronic document includes image data defining a picture of the document and text data extracted from the image data.

7. The document manage system of claim 1, further including a graphical user interface, said graphical user interface further including:
a first portion containing an image of an accessed document within the document manage system; and
a second portion containing a plurality of identifiers for accessing each of the electronic documents contained in an electronic customer file.

8. The document manage system of claim 1, wherein a control module further generates an identifier associated with a particular electronic customer file.

9. The document manage system of claim 8, wherein the control module further associates a document being scanned with the particular electronic customer file responsive to scanning of the identifier.

10. The document manage system of claim 8, wherein the control module creates the particular electronic customer file responsive to scanning of an identification document associated with a customer.

11. The document manage system of claim 8, wherein the control module places a signature on an accessed document responsive to input from an electronic signature pad.

12. The document management system of claim 1, wherein the control module extracts data from the electronic customer files to generate an input for at least one display, the input causing generation of status indicators on the display indicating status of sales associated with the electronic customer files.

13. The document management system of claim 12, wherein the status indicators are provided to at least one of a sales manager, an F & I manager and a general manager in real time.

14. A method for managing documents for a purchase transaction, comprising the steps of:
storing a plurality of electronic customer files in a database, the electronic customer files containing text data and image data;
receiving from the dealer management system forms for the generation of the text data and the image data; and
assembling a portion of electronic documents in an electronic customer file in the database into a distribution package, wherein the portion of the electronic documents that are assembled is determined based upon a destination third party for the distribution package.

15. The method of claim 14, further including the steps of:
receiving scanned image data of a physical document; and
extracting the text data from the scanned image data.

16. The method of claim 15, wherein the step of extracting further comprises the step of associating particular attributes with a scanned documents to extract the text data responsive to a user provided indication.

17. The method of claim 15, further including the step of creating the scanned image data from a scanned physical document.

18. The method of claim 14, further including the step of generating an identifier associated with a particular electronic customer file.

19. The method of claim 18, further including the step of associating a document being scanned with the particular electronic customer file responsive to scanning of the identifier.

20. The method of claim 18, further including the step of creating the particular electronic customer file responsive to scanning of an identification document associated with a customer.

21. The method of claim 18, further including the step of placing a signature on an accessed document responsive to input from an electronic signature pad.

22. The method of claim 16, further including the steps of:
extracting data from the electronic customer files; and
generating an input for at least one display, the input causing generation of status indicators on the display indicating status of sales associated with the electronic customer files.

23. The method of claim 22, wherein the step of generating further comprises providing the status indicators to at least one of a sales manager, an F & I manager and a general manager in real time.
